(19) United States
(12) Patent Application Publication
(10) Pub. No.: US 2008/0196364 A1
(43) Pub. Date: Aug. 21, 2008

(54) Oil Separating Apparatus and Cylinder Head Cover for an Internal Combustion Engine

(76) Inventors: Manfred Brand, Elmenhorst (DE); Mathias Reibe, Wittenburg (DE)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/030,328

(22) Filed: Feb. 13, 2008

(30) Foreign Application Priority Data
Feb. 20, 2007 (DE) DE102007008672.7

(51) Int. Cl. B01D 47/16

(52) U.S. Cl. 55/290

(57) ABSTRACT

An oil separating apparatus for an internal combustion engine comprises an upstream oil-separating element for through flowing blow-by gas, a downstream oil-separating element for through flowing blow-by gas connected in series with said upstream oil-separating element, and a hollow space on the outlet side of the upstream oil-separating element, wherein in an oil drain path of the downstream oil-separating element an oil return closed by means of a reed valve is provided, wherein the oil return on the outlet side terminates in said hollow space, wherein the hollow space comprises a further oil return which is closed by a further reed valve.

The invention relates to an oil separating apparatus and a cylinder head cover for an internal combustion engine.

For redirecting oil separated by an oil separator from a cylinder head cover into the engine oil circuit systems are known which are based on a pump driven by auxiliary energy (U.S. Pat. No. 2,688,316, DE 84 33 272 U, DE 41 01 203 A1) or a valve controlled from the outside (DE 195 15 482 C2). These systems are expensive.

DE 198 13 702 C1 discloses a system which automatically, through the effect of gravity alone, allows oil separated by means of an oil separator to flow back into the crankcase via a siphon. However, this system is position-sensitive. In addition, accelerations as well as suddenly occurring pressure fluctuations, for example as a result of a sudden change of the engine operating mode, can result in emptying or insufficient filling of the siphon and thus in a short circuit via the separator.

In DE 20 2004 004 801 U1 and DE 20 2004 004 802 U1 a pump system is proposed which utilizes pressure pulsations in the crankcase for discharging the oil separated in an oil separator without auxiliary energy from the outside.

With oil-separating elements connected in series, for example at least two oil separators connected in series or an oil-separating pressure control valve series-connected with at least one oil separator, the crankcase pressure is present at the return of the last oil-separating element on the dirty side and a pressure, which is substantially reduced by the pressure drop across all oil-separating elements is present on the clean side. Owing to the large pressure differential, even minor leakages can result in the undesirable entry of already separated oil or, if applicable, splash oil in the clean space of the last oil-separating element via the return.

The object of the present invention is to provide an oil separating apparatus and a cylinder head cover wherein a reliable oil return in particular without external control or supply of auxiliary energy is achieved with simple means.

According to the invention, the reed valves with spring tongues of thin spring steel can follow the rapid pressure fluctuations or pulsations caused by the piston movements and charge changes without substantial inertial delay and transport oil back even when there is no pressure drop to the crankcase on the average over time, since—because of phase shifts or different forms of vibration of the crankcase pulsations relative to the intake tract pulsations—there are short periods of pressure gradients which make possible drainage of the separated oil. In addition, the oil column present upstream of the reed valve increases the opening pressure on the spring tongue.

However, reed valves do not completely seal the oil drain openings. To prevent that oil is sucked back in opposite direction through the spring tongue return, the invention according to a further feature provides that the oil return of the downstream oil-separating element on the outlet side terminates in a hollow space arranged in the cylinder head cover on the gas or oil outlet side of the upstream oil-separating element. The hollow space is thus substantially at the same pressure level as the upstream oil-separating element on its outlet side. Because of this step or cascade arrangement of the oil returns, less than the full pressure differential between crankcase and intake tract is present at the oil return of the downstream oil-separating element, but rather a reduced pressure differential which substantially corresponds to the pressure dropping via the downstream oil-separating element. Generally speaking, a reduced pressure differential is present at each oil return of the cascade which substantially corresponds to the pressure dropping via the respective oil-separating element. As a result, leakages of oil or of unpurified gas contrary to the oil return direction because of excessive pressure differentials can be counteracted according to the invention. Leakage can also be counteracted through a reduced spring tongue thickness of 0.15 mm maximum, further preferentially in the range from approximately 0.04 mm to 0.12 mm, for example approximately 0.07 mm or approximately 0.10 mm.

Preferentially the spring tongue of the reed valves rests on a corresponding bearing without preload so that with the engine switched off the separated oil is able to flow back into the oil household due to gravity. Preferentially the seat of the bearing has a high surface finish so that the spring tongue closes even with low or minimal pressure differential against the return direction.

The invention can be applied to any arrangements and embodiments of series-connected oil-separating elements. In a preferred embodiment a pressure control valve which is provided anyhow is simultaneously utilized as oil-separating element.

In the following, the invention is described by means of advantageous exemplary embodiments making reference to the enclosed drawings. Here it shows:

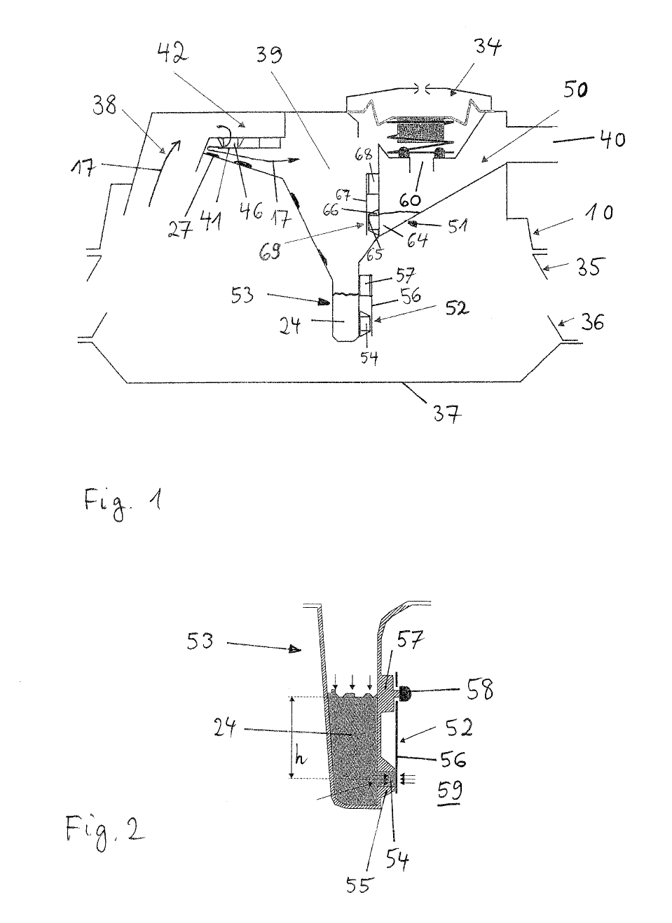

FIG. 1: a schematic cross-sectional view of an internal combustion engine;

FIG. 2: a cross-section through an oil return shown in FIG. 1;

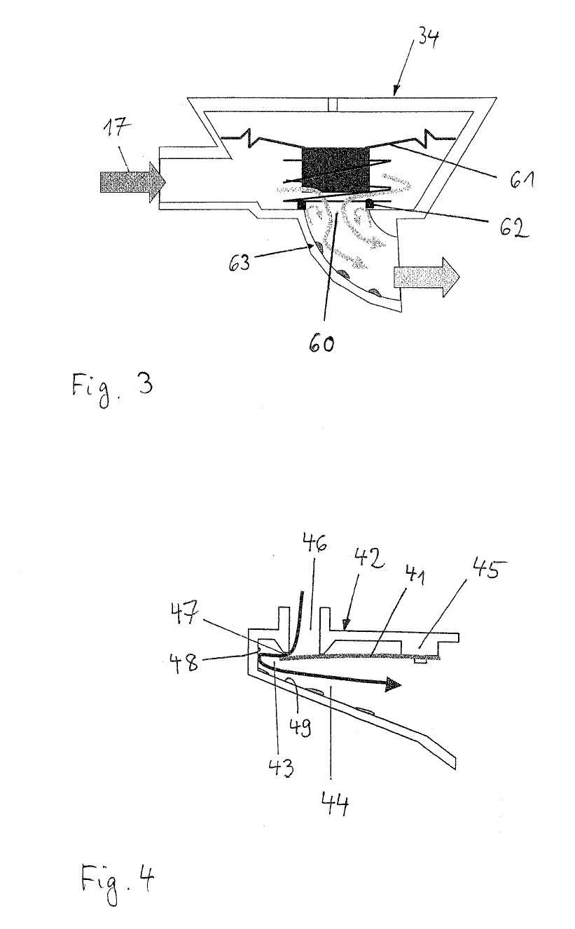

FIG. 3: a cross-section through a pressure control valve;

FIG. 4: a cross-section through the oil separator from FIG. 1; and

FIGS. 5 to 9: schematic cross-sectional views of an internal combustion engine in further embodiments.

The internal combustion engine shown in FIG. 1 comprises cylinder head cover 10, cylinder head 35, crankcase 36 and oil pan 37. The cylinder head cover 10 preferably manufactured of plastic comprises a gas inlet region 38 for oil-laden blow-by gas 17, which, by way of ducts for example provided in the engine housing, is directed from the crankcase 36 into the cylinder head cover 10. The blow-by gas 17 enters an oil separator 42 through a gas inlet 46. In the oil separator 42, oil 27 contained in the blow-by gas 17 is separated and, under the effect of gravity drains into an oil return 53 via which the oil is able to flow back into the engine household or into the oil pan 37. The cleaned gas flows from the oil separator 42 through a first clean space 39 via a pressure control valve 34 to a gas outlet opening 40, through which the cleaned gas reaches the intake tract of the engine.

The oil return 53 for the oil separator 42 is shown in detail in FIG. 2. It comprises an oil reservoir 24 open towards the top with an oil drain opening 54. The oil drain opening 54 is closed by a free end of a spring tongue 56 which, on the other end, is attached to the cylinder head cover 10 via fasteners 57, 58. The spring tongue 56 rests on the plane seat 55 without preload, so that the oil drain opening 54 is not completely sealed. The oil accumulated in the oil reservoir 24 can thus drain off merely through gravity and the effect of the oil column h on the spring tongue 56 with the engine stationary.

With the engine running, the spring tongue 56 closes the oil drain opening 54 in a sealing manner, when the pressure under the valve cover is greater than the sum of the pressure in the clean space 39 and the pressure imparted in the oil reservoir 24 through the oil column h. In this way it is effectively prevented that already separated oil or splash oil or unpurified gas from the space 59 under the valve cover is sucked back into the clean space 39. The spring tongue 56 thus forms a reed valve 52.

Because of periodic pressure fluctuations there are periodic time intervals in the range of a few ms preferably at engine speeds in the lower and medium load range in which the pressure in the clean space 39 is higher than the pressure in the space 59 below the cylinder head cover. In these time intervals the spring tongue 56 exposes a gap through which the oil from the oil reservoir 24 is able to drain through the oil drain opening 54 into the space 59 behind the spring tongue 56. Under such conditions oil is periodically pumped back into the oil household through the oil return 53, even if on the time average the pressure under the valve cover is greater than the pressure in the clean space 39.

The pressure control valve 34 in the embodiment according to FIG. 1 is designed as an oil-separating element. This is explained in FIG. 3. In the controlling state of the pressure control valve 34 a narrow gap forms between diaphragm 61 and nozzle 62 in order to achieve the desired pressure loss and thus the vacuum limitation upstream of the pressure control valve 34. This cross-sectional constriction results in an increase of the flow velocity. The following redirection and swirling of the gas flow in the gas outlet opening 60 throws particles from the gas flow against the wall 63, where they condense into droplets, adhere and drain off.

To discharge the oil separated in the pressure control valve 34 a corresponding oil return 51 is provided (see FIG. 1), which is similar to the oil return 53 of the oil separator 42 shown in FIG. 2. The oil return 51 comprises an oil reservoir 64 with an oil drain opening 65. The oil drain opening 65 is closed by the free end of a spring tongue 67 which, on the other end, is attached to the cylinder head cover 10 via fasteners 68. The spring tongue 67 rests on the plane seat 66 without preload so that the oil drain opening 65 is not sealed completely. The oil accumulated in the oil reservoir 64 can therefore drain off merely through gravity and the effect of the oil column on the spring tongue 67 with the engine stationary.

With the engine running, the spring tongue 67 closes the oil drain opening 65 in a sealing manner, when the pressure in the clean space 39 of the oil separator 42 is greater than the sum of the pressure in the clean space 50 of the pressure control valve 34 and the pressure imparted in the oil reservoir 64 by the oil column. In this way it is prevented that less cleaned gas from the clean space 39 of the oil separator 42 is sucked into the clean space 50 of the pressure control valve 34. The spring tongue 67 thus forms a reed valve 69. Through the arrangement of the second oil return 51, wherein the oil drain opening 65 terminates in the clean space 39 connected upstream and not in the space 59 below the cylinder head cover 10, the pressure acting on the spring tongue 67 in opposite direction is limited to the pressure loss in the pressure control valve 34. In addition, the second oil return 51 is not exposed to any splash oil from the region below the cylinder head cover 10.

The spring tongue 56 and/or the spring tongue 67 are expediently designed so that they are able to follow the rapid pressure changes in the engine or in the intake tract without substantial inertia delay. To this end, the spring tongues 56, 67 preferably consist of thin spring steel with a maximum thickness of 0.15 mm, preferentially in the range from approximately 0.04 to 0.12 mm, for example approximately 1.0 mm or approximately 0.07 mm.

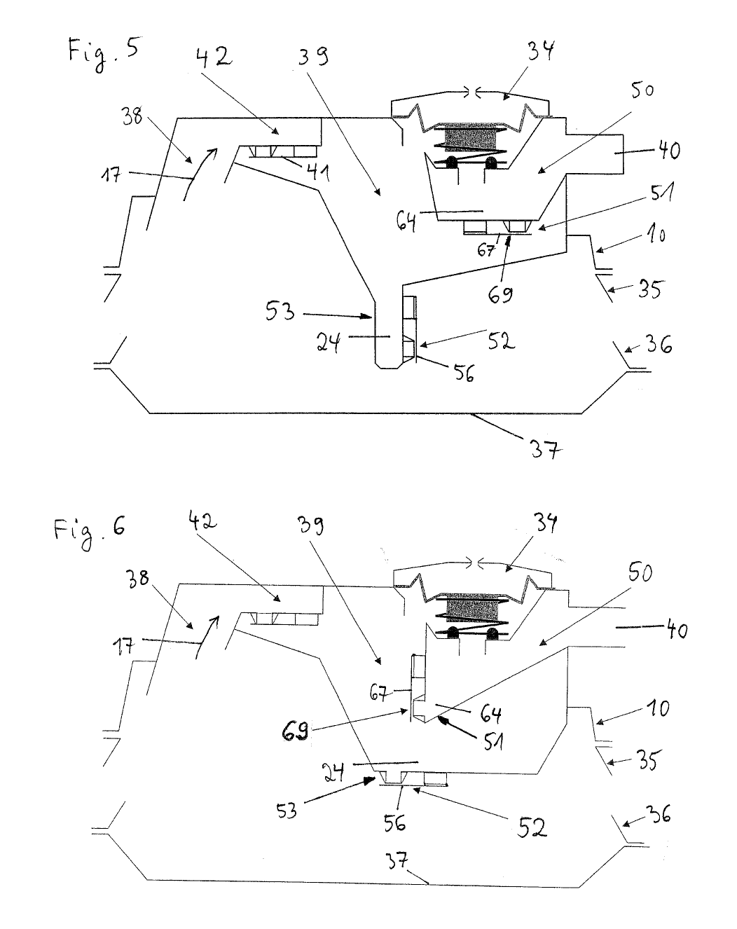

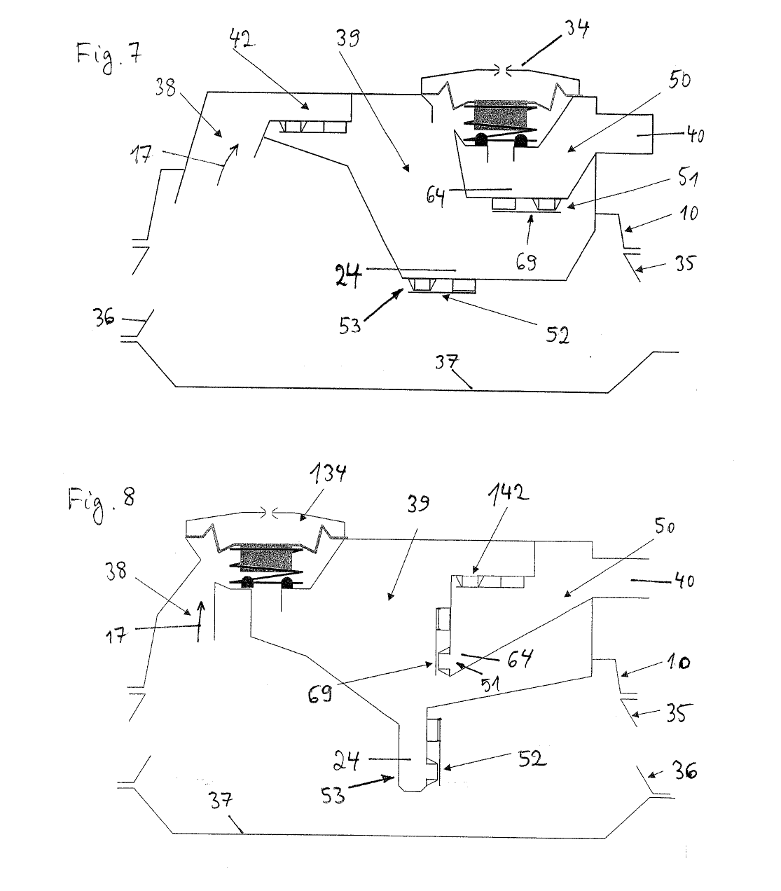

An embodiment of the oil separator 42 from FIG. 1 is shown in detail in FIG. 4. The embodiment according to FIG. 4 corresponds to the embodiments according to FIGS. 5, 6 from patent application U.S. Ser. No. 12/017,442, the corresponding disclosure of which is incorporated by reference in the present application. The spring tongue 41 arranged on the inlet side on one end is clamped cantilever-like in a clamping device 45. The other end of the spring tongue 41 in the position of rest covers the gas inlet opening 46 of the oil separator 42, which can for example be circular. The free end of the spring tongue 41 is subjected to the oil-laden blow-by gas 17. Because of the pressure loading the spring tongue 41 exposes a gap 47 through which the blow-by gas flows with high velocity into the separating chamber 43 connected downstream.

In the separating chamber 43 a baffle wall 48 expediently having a predominantly vertical component relative to the spring tongue 41 in the position of rest and preferentially oriented approximately vertically to the spring tongue 41 in the position of rest is provided. The gas flow entering through the gap 47 thus proceeds approximately vertically in the direction of the baffle wall 48 and is deflected along the baffle wall 48. Because of the inertia of the oil and dirt particles in the blow-by gas said particles are separated on the baffle wall 48. The oil separated on the baffle wall 48 drains on the floor 49 of the separating chamber 43 and the outlet chamber 44 connected downstream to the oil return 53. In order to obtain as high as possible a separating effect the gas flow is discharged through an outlet chamber 44 connected downstream in such a manner that on the baffle wall 48 a redirection of the gas flow in the direction opposite to that of the flow direction through the gap 47 into the separating chamber 43 occurs. The greater the gas pressure load on the spring tongue 41, the greater is the gap 47 for the blow-by gas exposed by the spring tongue 41 in the usual working range. The spring tongue oil separator 42 therefore exhibits adaptive behaviour.

In another embodiment the or at least one oil separator is formed according to the FIGS. 4, 5 from U.S. Pat. No. 7,080,636 B2, the corresponding disclosure of which is incorporated by reference in the present application.

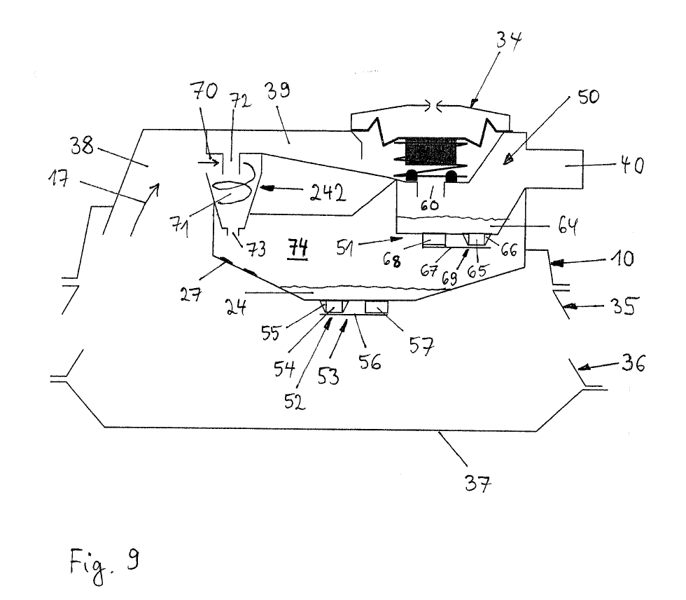

The invention is not restricted to oil separators with a spring tongue on the inlet side, as shown in FIG. 4, but can be applied to any other oil-separating elements. In the embodiment of FIG. 9, which will be explained later on, the cylinder head cover 10 for example comprises a cyclone oil separator 242. In an embodiment that is not shown the cylinder head cover 10 for example comprises at least one vortex chamber oil separator, which preferentially is embodied without immersion tube and/or is co-shaped in cross section, as is described in the application patent application U.S. Ser. No. 11/987,519 the corresponding disclosure of which is incorporated by reference in the present application.

FIGS. 5 to 7 show alternative embodiments which differ in the orientation of the oil returns 51, 53 from the embodiment according to FIG. 1. In the embodiment according to FIG. 5 the oil return 51 associated with the pressure control valve 34 is arranged horizontally instead of vertically. In the embodiment according to FIG. 6 the oil return 53 associated with the oil separator 42 is arranged horizontally instead of vertically. In the embodiment according to FIG. 7, both spring tongues 56, 67 are arranged horizontally. The Figures make clear that the reed valves 52, 69 can be installed position-insensitively, in contrast with known siphon closures of oil returns.

In the embodiment shown in FIG. 8 the pressure control valve 134 is arranged in flow direction upstream of the oil separator 142.

In the embodiment according to FIG. 9 the first oil separator 242 is a cyclone oil separator with a tangential gas inlet 70, a vortex chamber 71, an immersion tube 72 as gas outlet and an oil drain opening 73, through which the oil separated in the vortex chamber 71 drains into an oil reservoir chamber 74. The first oil return 53 closed with the reed valve is arranged in the oil reservoir chamber 74. The embodiment according to FIG. 9 illustrates that the first oil return 53 need not be in a close spatial relationship with the first oil separator 242, but is merely arranged in the oil drain path of the first oil separator 242 in the cylinder head cover 10. The second oil return 51 of the pressure control valve 34 in this embodiment terminates in the oil reservoir chamber 74. This illustrates that the second oil return 51 need not necessarily terminate in the clean space 39 of the first oil-separating element. The second oil return 51, too, need not be in any close spatial relationship with the second oil-separating element, but is merely arranged in the oil drain path of the second oil-separating element in the cylinder head cover 10. The second oil-separating element for example in an embodiment that is not shown can be a cyclone separator with an oil reservoir chamber connected downstream.

The invention is not restricted to two oil-separating elements connected in series. Additional oil-separating elements arranged in parallel and/or in series can be provided, wherein these can be vortex chamber and/or spring tongue oil separators. Here, the term spring tongue oil separator is not restricted to oil separators with a spring tongue on the inlet side. One or several additional vortex chamber separators with reed valve on the outlet side can for example be provided as well. It is furthermore not necessary for the pressure control valve to be utilised as oil-separating element as shown in the FIGS. 1 and 5 to 9. It also comprises the series connection of at least two oil separators which substantially have no pressure control function.

In the embodiments shown in the Figures, the oil separating elements, the hollow space and the reed valves are integrated in a cylinder head cover. However, this need not be the case; the invention is also applicable to an oil separating apparatus separate from the cylinder head cover.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. An oil separating apparatus for an internal combustion engine, comprising an upstream oil-separating element for through flowing blow-by gas, a downstream oil-separating element for through flowing blow-by gas connected in series with said upstream oil-separating element, and a hollow space on the outlet side of the upstream oil-separating element, wherein in an oil drain path of the downstream oil-separating element an oil return closed by means of a reed valve is provided, wherein the oil return on the outlet side terminates in said hollow space, wherein the hollow space comprises a further oil return which is closed by a further reed valve.

2. The apparatus according to claim 1, wherein a spring tongue of the reed valves rests without preload on a corresponding bearing.

3. The apparatus according to claim 1, wherein a spring tongue of the reed valves has a maximum thickness of 0.15 mm.

4. The apparatus according to claim 1, wherein a spring tongue of the reed valves has a maximum thickness of 0.1 mm.

5. The apparatus according to claim 1, wherein a spring tongue of the reed valves has a maximum thickness in the range from 0.04 to 0.08 mm.

6. The apparatus according to claim 1, wherein the hollow space is a clean space on the gas outlet side of the upstream oil-separating element.

7. The apparatus according to claim 1, wherein the hollow space is an oil reservoir chamber on the oil outlet side of the upstream oil-separating element.

8. The apparatus according to claim 1, wherein at least one of the oil-separating elements is formed by an oil separator with a spring tongue on the inlet side.

9. The apparatus according to claim 1, wherein at least one of the oil-separating elements is formed by a vortex chamber oil separator.

10. The apparatus according to claim l, wherein the oil-separating elements comprise at least one pressure control valve.

11. The apparatus according to claim 1, wherein the oil return of the upstream oil-separating element is arranged in a clean space of the upstream oil-separating element.

12. The apparatus according to claim 1, wherein the oil return of the upstream oil-separating element is arranged in an oil reservoir chamber of the upstream oil-separating element.

13. The apparatus according to claim 1, wherein the oil return of the downstream oil-separating element is arranged in a clean space of the downstream oil-separating element.

14. The apparatus according to claim 1, wherein the oil return of the downstream oil-separating element is arranged in an oil reservoir chamber of the downstream oil-separating element.

15. The apparatus according to claim 1, comprising at least one further oil-separating element.

16. A cylinder head cover for an internal combustion engine, comprising an upstream oil-separating element for through flowing blow-by gas, a downstream oil-separating element for through flowing blow-by gas connected in series with said upstream oil-separating element, and a hollow space on the outlet side of the upstream oil-separating element, wherein in an oil drain path of the downstream oil-separating element an oil return closed by means of a reed valve is provided, wherein the oil return on the outlet side terminates in said hollow space, wherein the hollow space comprises a further oil return which is closed by a further reed valve.

17. The cylinder head cover according to claim 16, wherein a spring tongue of the reed valves rests without preload on a corresponding bearing.

18. The cylinder head cover according to claim 16, wherein a spring tongue of the reed valves has a maximum thickness of 0.15 mm.

19. The cylinder head cover according to claim 16, wherein a spring tongue of the reed valves has a maximum thickness of 0.1 mm.

20. The cylinder head cover according to claim 16, wherein a spring tongue of the reed valves has a maximum thickness in the range from 0.04 to 0.08 mm.

21. The cylinder head cover according to claim 16, wherein the hollow space is a clean space on the gas outlet side of the upstream oil-separating element.

22. The cylinder head cover according to claim 16, wherein the hollow space is an oil reservoir chamber on the oil outlet side of the upstream oil-separating element.

23. The cylinder head cover according to claim 16, wherein at least one of the oil-separating elements is formed by an oil separator with a spring tongue on the inlet side.

24. The cylinder head cover according to claim 16, wherein at least one of the oil-separating elements is formed by a vortex chamber oil separator.

25. The cylinder head cover according to claim 16, wherein the oil-separating elements comprise at least one pressure control valve.

26. The cylinder head cover according to claim 16, wherein the oil return of the upstream oil-separating element is arranged in a clean space of the upstream oil-separating element.

27. The cylinder head cover according to claim 16, wherein the oil return of the upstream oil-separating element is arranged in an oil reservoir chamber of the upstream oil-separating element.

28. The cylinder head cover according to claim 16, wherein the oil return of the downstream oil-separating element is arranged in a clean space of the downstream oil-separating element.

29. The cylinder head cover according to claim 1, wherein the oil return of the downstream oil-separating element is arranged in an oil reservoir chamber of the downstream oil-separating element.
